(19) United States
(12) Patent Application Publication
(10) Pub. No.: US 2010/0151927 A1
(43) Pub. Date: Jun. 17, 2010

(54) Learning The Game Sports Officiating Simulation Device

(76) Inventor: Jacques Miles, New York, NY (US)

Correspondence Address: Jacques B. Miles, 455 West 37th Street, Unit 2306, New York, NY, 10018, US

(21) Appl. No.: 12/516,195

(22) PCT Filed: Nov. 22, 2006
(86) PCT No.: PCT/IB06/03310

§ 371 Date: Feb. 19, 2010

Related U.S. Application Data
(60) Provisional application No. 60/739,636, filed on Nov. 26, 2005.

(51) Int. Cl. A63F 13/00; G06F 19/00

(52) U.S. Cl. 463/4; 700/91

(57) ABSTRACT

An apparatus for simulating the experience of a sports official is disclosed. The apparatus includes a medium for displaying game content; a first input means for receiving a first input signal, wherein displayed game content is temporarily stopped or paused when a first input signal is received; and a timer for monitoring a pre-set time period for the display of game content.

### FIELD OF THE INVENTION

The present invention relates to a simulation apparatus, especially a simulation apparatus that enables a user to play the role of a sports official during a game.

### BACKGROUND

Every sport is governed by its own set of rules. During a sporting contest, one or more persons called officials administer the game by enforcing rules. Every level of sport—little league, middle school, high school, college, semi-pro, professional—require officials for the games to be played safely and properly. The officials who officiate our beloved games come from every segment of society and have varied knowledge, abilities, skills and experience.

During a game, regardless of the sport, it is not rare for a spectator to wish an official(s) working a particular game was doing a better job; making fewer mistakes and administering the game in a more efficient manner. The level of frustration experienced by a spectator is especially high if the official(s) blows an important call and/or influences the outcome of the game. Sometimes an official(s) performs so poorly that a spectator believes he/she can do a better job of officiating than the official(s) who are trained and get paid to officiate.

The uneven, and sometimes outright poor, performance of an official(s) as observed by spectators can be at least partly attributed to the way officials learn their craft. The conventional way for an official to learn his/her craft is through study of the appropriate rules along with trial and error experience gained by officiating actual games. Because there are only so many games per season for an official to officiate, the learning curve for a new official is difficult and it takes a long time for a new official to gain proficiency.

In light of the limited number of actual games played per season for an official in a particular sport to practice his/her technique and gain proficiency, there is clearly demand for an apparatus capable of simulating the experience of a sports official that enables an official to gain competence officiating a particular sport by training under game-like situations; seeing and then identifying penalties in real games. The present invention provides such an apparatus. The present invention provides a device for sports officials to increase their level of skill by simulating the situations and conditions they encounter during actual games. By increasing the competence level of sports officials, the present invention enhances the overall experience of the sports we love.

### SUMMARY OF THE INVENTION

It is an object of the present invention to provide an apparatus capable of producing a simulation experience for sports officials and others that allows them to develop and/or improve officiating skills without having to officiate an actual game.

It is an object of the present invention to provide an apparatus that facilitates learning the rules of a particular sport; such an apparatus is particularly useful for persons who have had no or limited exposure to a particular sport but desire to learn more about the particular sport and how it is played.

### DESCRIPTION OF THE INVENTION

As used herein, the term “official” refers to a person who administers a game and enforces the rules during the game (i.e., a football game, a basketball game, a baseball game, a hockey game, a soccer game, a boxing match, a rugby match, etc.). Terms such as “referee”, “umpire”, “head linesman”, “sports official”, etc. are considered to be synonymous with the term “official”.

As used herein, the term “penalty” refers to a violation of a particular rule in a given sport. Terms such as “infraction”, “foul”, etc. are considered to be synonymous with the term “penalty”.

As used herein, apparatus and device refer to a “computing system” or other which performs in a manner similar to a computer or other device having a processor and memory capable of performing the described simulation. The term personal computing device encompasses various models made by manufactures such as, but not limited to, Dell computer, Gateway computer, Apple, etc. and includes video game consoles such as the X-Box from Microsoft, the Playstation from Sony, PSP from Sony, the Gameboy system from Nintendo, etc. Another example of a suitable personal computing device is a television set having a set top box or TiVo. As used herein, the term “computing system” encompasses telephones; particularly mobile and cellular telephones.

As used herein, the term “displaying” encompasses showing video, graphics, and/or generating audible content. Video content can be displayed on a screen such as a television screen, a computer screen, etc. Audio content can be displayed over one or more speakers and displayed simultaneously with video content displayed on a screen.

The present invention is an apparatus that simulates the experience of a sports official comprising (a) a medium over which game content is displayed and (b) a first input means capable of receiving a first input signal.

According to the present invention, the apparatus comprises a medium over which game content can be displayed. The medium can be a visual medium such as a screen; an audible medium such as loudspeakers; etc.

In a non-limiting embodiment of the invention, the game content is recorded from a previously played sporting event. The game content can be from any sport including, but not limited, to a football game, a basketball game, a baseball game, a hockey game, a soccer game, a boxing match, a tennis match, etc. The game content can be from any level of sport including little league, high school, college, or professional.

It is envisioned that the game content will be provided by a sports league such as the National Basketball Association, National Football Association, National Baseball League, National Hockey League, U.S. Soccer League or by a collegiate association such as the National Association of Intercollegiate Athletics.

In a non-limiting embodiment of the invention, the sporting event from which the game content originates has been filmed using various camera angles. For example, game content from a football game can be filmed from a camera(s) in one or more endzones (i.e., endzone camera angle), from a camera(s) on one or more sidelines (i.e., sideline camera angle), from a camera(s) over the stadium (i.e., overhead camera angle), etc. Thus, in this embodiment, the camera angle of displayed game content can be changed to give a user (a person viewing the game content or using the invention is referred to herein as a “user”) a different vantage point. The display of game content is not restricted to the view from any particular camera angle.

In a non-limiting embodiment of the invention, the camera angle of the displayed game content can be changed during the simulation. For example, the camera angle of the displayed content can be changed upon receiving a “camera angle shifting signal” from, for example, an endzone camera angle to a sideline camera angle. According to the present invention, the apparatus can comprise a “camera angle shifting input means” to receive the camera angle shifting signal. The camera angle shifting input means can be the same or different from the first input means.

The following scenario is included for illustrative purposes. The apparatus of the present invention is displaying game content from a sideline camera angle on the medium. The apparatus of the invention then receives a camera angle shifting signal that changes the camera angle of the visually displayed content. For example, the game content being displayed is from a side line camera angle, and a camera angle shifting signal is received to change the display of game content to an endzone camera angle.

When the game content originates from a sporting event that has been played at some point in the past, the original content contains footage of and relating to the officials who worked the event. If the officials at the original sporting event are visible and/or there is evidence of their participation present during the display of game content step of the present invention, the impact of the present invention might be reduced. Therefore, in a non-limiting embodiment of the invention, the game content of the invention is edited before it is displayed in a manner such that the presence of officials at the original sporting contest and/or any evidence of their presence which would negatively impact the simulation is deleted. In this embodiment, penalties committed during the actual game and related activities (i.e., throwing a flag, blowing a whistle, enforcement of a penalty, etc.) are edited out of the game content and are not apparent/detectable when the game content is being displayed.

In another non-limiting embodiment of the invention, the game content is edited in a manner that enhances the simulation. For example, portions of the displayed content can be digitally enhanced to sharpen video images or increase the scale of the video (i.e., make players in the video content appear larger and make their movements more well defined).

According to the present invention, the apparatus stores and/or accesses game content in a number of ways. In a non-limiting embodiment of the invention, the apparatus receives game content that is transmitted from a server or similar device via the internet or other. The server or similar device can be at the same location as the apparatus or a location remote from the apparatus. In this embodiment, the apparatus receives game content transmitted from the server or other and received using equipment and methods which are well known in the art.

There are many ways in the art to transmit and receive digital and analog signals. An example of a suitable data transmission system for the transmission and receipt of game content is the on-demand system used by cable operators like Comcast. Another example of a suitable method is described in U.S. Pat. No. 5,130,792 assigned to USA Video Inc. (Dallas, Tex.).

In the embodiment described above, the apparatus can immediately display game content upon receipt or it can store the game content in a conventional manner for future display.

In another non-limiting embodiment of the invention, the apparatus stores the game content. For example, game content is stored on a hard drive or similar. The game content can originate from a server, disc or any other device and then be transferred and stored on the apparatus.

A subscription model can be used to authorize access to a server or similar device and regulate the transmission of game content from the server/device. Internet based subscription systems such as TiVo are well known in the art.

In another non-limiting embodiment of the invention, the apparatus utilizes a digital video disc (DVD) or similar storage device to store the game content. At the appropriate time, the apparatus can read the DVD and display the game content.

In yet another non-limiting embodiment of the invention, the apparatus uses a conventional digital video recorder (DVR) to store the game content in digital form. At the appropriate time, the apparatus can communicate with the DVR and display the game content. An example of a DVR system is described in U.S. Pat. No. 6,674,960 assigned to Forgent Networks, Inc. (Austin, Tex.).

According to the present invention, the apparatus comprises a first input means. While the game content is being displayed, the first input means can receive a first input signal. Upon receipt of the first input signal, the apparatus stops or pauses the display of the game content. The apparatus receives the first input signal using equipment and methods which are well known in the art. The first input signal typically indicates a penalty has been observed.

The first input signal can be generate by a first input device such as a keyboard, joystick, or other similar device as is well known in the art. In a non-limiting embodiment of the invention, the first input device is a whistle or other device capable of making sound.

In the practice of the invention, the various input and output devices referred to herein can be connected using various input/output connectors and ports which are well known in the art. The various input/output devices can communicate with the apparatus of the invention by any suitable means such as, but not limited to, a wireless system such as “Bluetooth”, cable, etc.

In a non-limiting embodiment of the invention, the apparatus comprises a second input means capable of receiving a second input signal. The second input means can be the same or a different device from the first input means. The second input signal can be generated by a second input device. The second input signal can be generated and received using equipment and methods which are well known in the art.

The second input signal can be generated by a second input device such as a keyboard, joystick, or other similar device. The second input device can be the same device as the first input device or a different device.

The second input signal typically indicates a specific infraction. The term “specific infraction” refers to information such as, but not limited to, the type of infraction committed, who (which player) committed the infraction, etc. For example, in a football game, the type of infraction can be holding, clipping, grabbing a facemask, roughing the passer, being offsides, etc. For example, in a basketball game, the type of infraction can be double dribble, a blocking foul, a charge, travelling, etc.

In a non-limiting embodiment of the invention, the second input device is sensor capable of detecting and interpreting movement. For example, the sensor can detect and interpret particular body movements. If a person were to perform the body movement associated with a holding penalty in football, for example, the sensor would interpret the movement as such and generate an appropriate signal.

In a non-limiting embodiment of the invention, the display of game content is stopped or paused until the first input signal, and optionally, the second input signal is received. After the input signals are received, the display of the game content is resumed. Ideally, the display of game content resumes at the next point in the game that enables a smooth transition from where the first input signal was received (i.e., a penalty was observed). The display of game content continues until the apparatus receives another first input signal or the time period for the display of game content expires. The apparatus includes a timer for monitoring a pre-set time period for the display of game content and stopping the display upon the expiration of such time period.

The time period for the display of game content is typically determined before the game content is initially displayed. In a non-limiting embodiment of the invention, the time period is 5 minutes, 10 minutes, 20 minutes, 30 minutes, etc. The time period can be the entire length (i.e., from the start to the finish) of a game. There is no limitation on the time period for display of the game content.

In a non-limiting embodiment of the invention, the apparatus includes a means for calculating a score. The score is calculated after the time period for display of the game content expires. The score can be based on an evaluation of: the first input signals or the first and the second input signals. Because the first and second input signals represent the penalties called during the relevant time period by a user, that information can be evaluated against a control indicative of the actual penalties (i.e., the penalties determined to be present by an authoritative person or body as opposed to those observed by the user) committed in the game content displayed over the relevant time period. The score can be indicative of a user's level of competence to officiate a particular sport.

In a non-limiting embodiment of the invention, a computed score is displayed on the medium and/or is audibly conveyed after the time period has expired and the score has been calculated.

In a non-limiting embodiment of the invention, a score is generated based on (a) a number of correct calls; (b) a number of incorrect calls; and/or (c) a number of improper calls during a specified time period. As used herein, a correct call is a penalty that was called properly. For a correct call, two conditions must be present: (1) a penalty did occur in the displayed game content when (approximately) a first input signal was received and (2) the penalty was properly identified (a holding penalty was identified as a holding penalty; not a facemask penalty, for example).

The following illustrates a “correct call”, an “incorrect call” and an “improper call”. References to a penalty actually occurring in the displayed content and the specifics of the penalty refer to the judgment of an authoritative person or body.

In this example, the displayed game content is from a football game and shows a holding penalty. Game content is being displayed on the medium of the apparatus. A first input signal is received by the first input means approximately when the holding penalty occurs in the displayed game content. Thus, the first condition for a correct call is satisfied. A penalty did occur approximately when the first input signal was received.

Next, the second input means receives a second input signal that indicates the penalty observed was a holding penalty. Because the penalty was properly identified, both conditions for a correct call have been satisfied in this instance. If the second input signal had not indicated that a holding penalty was observed, both requirements for a correct call would not have been present. This would constitute an improper call.

If a penalty had not occurred in the displayed content approximately when the first input signal was received, this situation would represent an incorrect call. A penalty did not occur approximately when the first input signal was received.

As used herein, an improper call refers to the situation when the first condition (i.e., a penalty did occur approximately when the first input signal was received) for a correct call is satisfied, but the second condition (i.e., the proper identification of the infraction) is not. Had the second input signal been indicative of an illegal motion penalty as opposed to a holding penalty, the call would have been an improper call.

In a non-limiting embodiment of the invention, the apparatus comprises a means for rewinding and re-displaying game content. The rewinding and redisplaying of the game content can be accomplished using equipment and techniques which are well known in the art.

In a non-limiting embodiment of the invention, the apparatus comprises a means for accessing a database or similar that contains the rules of a particular sport (referred to herein, as a “rules database”) using equipment and techniques for searching content in a database which are well known in the art. This allows searches for particular rules to be conducted and displayed over the medium. An example of a suitable system for storing and searching information is a server archive-based editing and research system referred to in the industry as the SABER system. The rules database can be stored and/or accessed in a similar manner to the game content.

In a non-limiting embodiment, the rules database contains the rules of the National Football Association. In another embodiment, the rules database contains the rules of the Virginia High School Football Athletic Association. In yet another embodiment, the rules database contains the rules of the National Basketball Association.

In a non-limiting embodiment of the invention, the apparatus comprises a means for accessing a database or similar containing video content for the proper mechanics (mechanics database) using well known equipment and techniques. This allows searches of particular mechanics to be conducted and displayed over the medium. In a non-limiting example, the database or similar contains video content illustrating the proper mechanic for calls according to the National Football League. The mechanics database can be stored and/or accessed in a similar manner to the game content.

In a non-limiting embodiment of the invention, the apparatus comprises a means for accessing information about national and international officiating chapters. The apparatus can access the information and display it over the medium. In this embodiment, the database or similar of sports officiating chapters for various sports across the nation and/or globe is searchable. Based on user information such as zip code or other, the apparatus can display contact information for a sports officiating chapter in a desired area. In this manner, a person using the present invention who is interested in becoming a sports official can be directed to a local sports officiating organization in his/her area.

In a non-limiting embodiment, the apparatus of the invention utilizes one or more software programs or similar. As a result, the apparatus comprises a means for utilizing such software. The software can be written on a DVD or other programmable device as in known in the art so that it can be read and actuated by the apparatus. The apparatus of this invention is not limited to any particular computing platform such as a personal computer using a Windows operating system, a Sony PSP, a Microsoft X Box, a Nintendo gameboy, etc. The apparatus of the present invention can be any platform.

According to the present invention, the apparatus processes (transmitting, receiving, etc.) various input and output signals using equipment and methods which are well known in the art.

The apparatus utilized to practice the present invention can contain one or more video and/or graphic systems including components for receiving compressed and uncompressed graphics and video and for processing the received graphics and video into displayable format. The graphic display system can be any one capable of processing video input signals that may include analog video signals, digital video signals, etc. The analog signals can be, for example, NTSC, PAL and SECAM signals or any other conventional type of analog signal. The digital signals can be decoded MPEG signals or other format of digital video output.

Suitable methods for processing audio and video signals are well known in the art. A suitable method is described in U.S. Pat. No. 6,728,312 assigned to Forgent Networks, Inc. (Austin, Tex.).

We will now illustrate the practice of the invention when the game content is from a football game. In the practice of the invention, the apparatus contains at least one screen on which game content is displayed. The game content is from a previously recorded football game, and the original football game content has been edited in a manner such that there is no sign or indication of the officials who administered the actual game while the game content is being displayed. At some point during the display of the game content, the first input means of the apparatus receives a first input signal. The displayed game content is then stopped or paused.

The first input signal indicates a penalty has been observed. Next, a second input signal that indicates the specific infraction which was observed is received by the second input means. For example, the second input signal can indicate one of the following infractions occurred: a holding penalty, a clip, an illegal procedure, a facemask, etc.

After the second input signal is received, the display of the game content resumes at a place after which the first input signal was received. The apparatus continues to display game content until another first input signal is received or the time period for display expires. At the expiration of the time period, the apparatus calculates and displays a score.

If another first input signal is received before the time period for display of the game content expires, the apparatus repeats the sequence described above from when the first input signal is received.

The present invention also encompasses a system that includes the apparatus described above plus other devices such as the first input device and the second input device.

We will now illustrate the practice of the invention when the game content is from a basketball game. In the practice of the invention, the apparatus includes at least one screen on which game content is displayed. The game content is from a previously recorded basketball game, and the original basketball game content has been edited in a manner such that there is no sign or indication of the officials who administered the actual game while the game content is being displayed. At some point during the display of the game content, a first input signal is received by the first input means. The displayed game content is then stopped or paused.

The first input signal indicates a penalty has been observed. Next, the second input means of the apparatus receives a second input signal that indicates the specific infraction which was observed. For example, the second input signal can indicate one of the following infractions occurred: a double dribble, a traveling violation, a blocking foul, a charge, etc.

After the second input signal is received, the apparatus resumes the display of game content at a place after which the first input signal was received. The apparatus continues to display the game content until another first input signal is received or the time period for display expires. At the expiration of the time period, the apparatus calculates and displays a score.

If another first input signal is received before the time period expires for the displayed game content, the apparatus repeats the sequence described above from when the first input signal is received.

The apparatus of the present invention can be used as a simulator/training tool for officials at all levels and aspiring officials. The present invention also provides officials and aspiring officials an opportunity to test their knowledge and administration of the rules of a particular sport. The apparatus of the invention can also be used to introduce someone who is not knowledgeable about a particular sport to the rules of that sport and possibly develop a lifelong fan.

It will be readily appreciated by those skilled in the art that modifications may be made to the invention without departing from the concepts disclosed in the foregoing description. Such modifications are to be considered as included within the scope of the invention. Accordingly, the particular embodiments described in detail hereinabove are illustrative only and are not limiting as to the scope of the invention, which is to be given the full breadth of the appended claims and any and all equivalents thereof.

We claim:

1. An apparatus for simulating the experience of a sports official comprising
(a) a medium for displaying game content;
(b) a first input means for receiving a first input signal, wherein the the display of game content is temporarily stopped or paused when the first input signal is received; and
(c) a timer for monitoring a pre-set time period for the display of game content.

2. The apparatus according to claim 1, wherein the game content is recorded content from a previously played sporting contest.

3. The apparatus according to claim 2, wherein the game content is from a football game, a basketball game, a baseball game, a hockey game, or a soccer game.

4. The apparatus according to claim 1, wherein the first input signal is generated by a first input device.

5. The apparatus according to claim 1, wherein the first input signal indicates a penalty has been observed in the displayed game content.

6. The apparatus according to claim 1 further comprising a second input means for receiving a second input signal.

7. The apparatus according to claim 6, wherein the second input signal represents a specific infraction that has been observed in the displayed game content.

8. The apparatus according to claim 6, wherein the second input signal is generated by a second input device.

9. The apparatus according to claim 1 further comprising a camera angle shifting input means.

10. The apparatus according to claim 2, wherein the displayed game content is edited in a manner such that the presence of any officials at the actual game has been deleted.

11. The apparatus according to claim 1 further comprising a means for receiving content from a server or similar device via the internet or other.

12. The apparatus according to claim 1 further comprising a means for calculating a score.

13. The apparatus according to claim 1 further comprising a means for searching for and displaying information.

14. The apparatus according to claim 13, wherein the information is a particular rule.

15. The apparatus according to claim 13, wherein the information is a particular mechanic.

16. The apparatus according to claim 13, wherein the information is a particular officiating organization.

17. The apparatus according to claim 13, wherein the information is a particular rule, a particular mechanic and/or a particular officiating organization.

18. The apparatus according to claim 1, wherein the apparatus is selected from computers, video game consoles and telephones.
